(19) United States
(12) Patent Application Publication
(10) Pub. No.: US 2014/0010291 A1
(43) Pub. Date: Jan. 9, 2014

(54) Layer Dependency and Priority Signaling Design for Scalable Video Coding

(71) Applicant: VID SCALE, INC., Wilmington, DE (US)

(72) Inventors: Yong He, San Diego, CA (US); Yan Ye, San Diego, CA (US); Yuwen He, San Diego, CA (US)

(21) Appl. No.: 13/935,089

(22) Filed: Jul. 3, 2013

Related U.S. Application Data
(60) Provisional application No. 61/668,231, filed on Jul. 5, 2012.

(51) Int. Cl. H04N 7/32

(52) U.S. Cl. CPC H04N 19/00569
USPC 375/240.12

(57) ABSTRACT

Signaling of layer dependency and/or priority of dependent layers in a video parameter set (VPS) may be used to indicate the relationship between an enhancement layer and its dependent layers, and/or prioritize the order of the dependent layers for multiple layer scalable video coding of HEVC for inter-layer prediction. A method may include receiving a bit stream that includes a video parameter set (VPS). The VPS may include a dependent layer parameter that indicates a dependent layer for an enhancement layer of the bit stream. The dependent layer parameter may indicate a layer identification (ID) of the dependent layer. The VPS may indicate a total number of dependent layers for the enhancement layer. The VPS may include a maximum number of layers parameter that indicates a total number of layers of the bit stream. The total number of dependent layers for the enhancement layer may not include the enhancement layer.

### CROSS-REFERENCE TO RELATED APPLICATIONS

This application claims the benefit of U.S. Provisional Patent Application No. 61/668,231, filed Jul. 5, 2012, the contents of which are hereby incorporated by reference herein.

### BACKGROUND

Digital video compression technologies may be developed and standardized to enable efficient digital video communication, distribution, and consumption. ISO/IEC and ITU-T provides standards, such as H.261, MPEG-1, MPEG-2, H.263, MPEG-4 (part-2) and H.264/AVC (MPEG-4 part 10 Advance Video Coding), for example. Joint development by ITU-T Video Coding Experts Group (VCEG) and ISO/IEC MPEG provides another video coding standard, High Efficiency Video Coding (HEVC).

### SUMMARY

Signaling of layer dependency and/or priority of dependent layers in a video parameter set (VPS) may be used to support multiple layer scalable extension of HEVC, such as but not limited to, temporal and inter-layer motion compensated prediction for scalable video coding of HEVC. For example, signaling layer dependency and priority in VPS may be used to indicate the relationship between an enhancement layer and its dependent layers, and/or prioritize the order of the dependent layers for multiple layer scalable video coding of HEVC for inter-layer prediction. A method may include receiving a bit stream that includes a video parameter set (VPS). The VPS may include a dependent layer parameter that indicates a dependent layer for an enhancement layer of the bit stream. The dependent layer parameter may indicate a layer identification (ID) of the dependent layer. For example, the dependent layer parameter may indicate the layer ID of the dependent layer as a function of a difference between the dependent layer and the enhancement layer. A device may perform the method. The device may be a decoder and/or a wireless transmit/receive unit (WTRU).

The VPS may indicate a total number of dependent layers for the enhancement layer. The VPS may include a maximum number of layers parameter that indicates a total number of layers of the bit stream. The total number of dependent layers for the enhancement layer may not include the enhancement layer. The enhancement layer may have one or more dependent layers, and an order of one or more dependent layer parameters in the VPS may indicate a priority of the one or more dependent layers for inter-layer prediction of the enhancement layer.

The method may include decoding the bit stream in accordance with the VPS. Decoding the bit stream in accordance with the VPS may include performing inter layer prediction for the enhancement layer using the dependent layer indicated by the dependent layer parameter. The bit stream is encoded according to a high efficiency video coding (HEVC) coding standard.

A method of signaling inter-layer dependency in a video parameter set (VPS) may include defining two or more layers for a bit stream, defining a dependent layer for an enhancement layer of the bit stream, and signaling, via the VPS, a dependent layer parameter that indicates the dependent layer for the enhancement layer of the bit stream. The dependent layer parameter may indicate a layer identification (ID) of the dependent layer. The VPS may indicate a total number of dependent layers for the enhancement layer. The total number of dependent layers of the enhancement layer may not include the enhancement layer. The VPS may include a maximum number of layers parameter that indicates a total number of layers of the bit stream. A device may perform the method. The device may be an encoder and/or a WTRU.

The method may include defining one or more dependent layers for the enhancement layer, and signaling, via the VPS, one or more dependent layer parameters that indicate the one or more dependent layers for the enhancement layer. The order of the one or more dependent layer parameters in the VPS may indicate a priority of the one or more dependent layers for inter-layer prediction of the enhancement layer.

### BRIEF DESCRIPTION OF THE DRAWINGS

FIG. 1 is a diagram illustrating an example scalable structure with inter-layer prediction for HEVC spatial scalable coding.

FIG. 2 is a diagram illustrating an example relationship among video picture, reference picture set, DPB, and reference picture list.

FIG. 3 is a diagram illustrating an example mixed special and SNR scalable coding structure.

FIG. 4 is a flow chart of an example layer dependency and priority signaling procedure.

FIG. 5 is a diagram illustrating an example scalable coding structure with temporal and inter-layer prediction.

FIG. 6 is a flow chart of an example reference picture set arrangement in VPS.

FIG. 7 is a flow chart of another example reference picture set arrangement in VPS.

FIG. 8 is a flow chart of an example decoding process of reference picture list construction.

FIG. 9 is a block diagram illustrating an example of a block-based video encoder.

FIG. 10 is a block diagram illustrating an example of a block-based video decoder.

FIG. 11A is a system diagram of an example communications system in which one or more disclosed embodiments may be implemented.

FIG. 11B is a system diagram of an example wireless transmit/receive unit (WTRU) that may be used within the communications system illustrated in FIG. 11A.

FIG. 11C is a system diagram of an example radio access network and an example core network that may be used within the communications system illustrated in FIG. 11A.

FIG. 11D is a system diagram of another example radio access network and another example core network that may be used within the communications system illustrated in FIG. 11A.

FIG. 11E is a system diagram of another example radio access network and another example core network that may be used within the communications system illustrated in FIG. 11A.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

Video applications, such as IPTV, video chat, mobile video, and streaming video, for example, may be deployed in heterogeneous environments. Such heterogeneity may exist on the client side and/or on the network side. On the client side, a three-screen scenario (e.g., a smart phone, a tablet, and a TV) may dominate the market. The client display's spatial resolution may be different from device to device. On the network side, video may be transmitted, for example, across the Internet, WiFi networks, mobile (e.g., 3G and 4G) networks, and/or any combination thereof. Scalable video coding may be utilized, for example, to improve the user experience and video quality of service. In scalable video coding, the signal may be encoded once at the highest resolution, while decoding may be enabled from subsets of the streams depending on the specific rate and resolution requested by certain application and/or supported by the client device.

The term resolution may refer to a number of video parameters, including but not limited to, spatial resolution (e.g., picture size), temporal resolution (e.g., frame rate), and/or video quality (e.g., subjective quality such as but not limited to MOS, and/or objective quality, such as but not limited to PSNR, SSIM, and/or VQM), for example. Other video parameters may include chroma format (e.g., YUV420, YUV422, and/or YUV444), bit-depth (e.g., 8-bit and/or 10-bit video), complexity, view, gamut, and/or aspect ratio (e.g., 16:9 and/or 4:3). Video standards, including but not limited to, MPEG-2 Video, H.263, MPEG4 Visual, and/or H.264, for example, may include one or more tools and/or profiles that support scalability modes. HEVC scalable extension may support spatial scalability (e.g., the scalable bitstream may include signals at more than one spatial resolution) and quality scalability (e.g., the scalable bitstream may include signals at more than one quality level).

View scalability (e.g., the scalable bitstream may include both 2D and 3D video signals) may utilized, for example, in MPEG. Spatial and/or quality scalability may be utilized herein to discuss a plurality of scalable HEVC design concepts. The concepts described herein may be extended to other types of scalabilities.

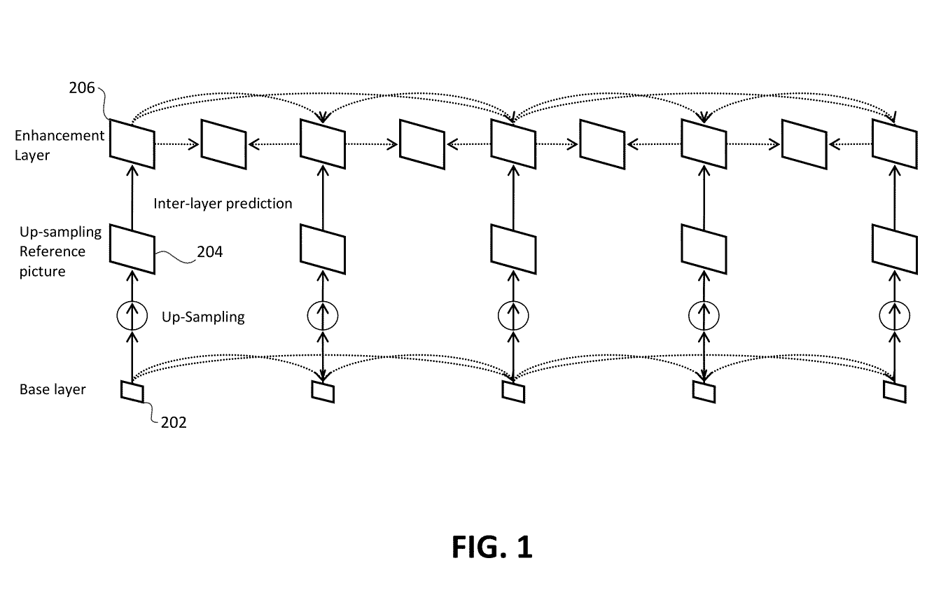

Inter-layer prediction may be used to improve the scalable coding efficiency and/or make scalable HEVC system easier for deployment, for example, due to the strong correlation among the multiple layers. FIG. 1 is a diagram illustrating an example of a coding structure designed for general scalable coding. The prediction of an enhancement layer may be formed by motion-compensated prediction from inter-layer reference pictures processed from the reconstructed base layer signal (e.g., after up-sampling, for example, if the spatial resolutions between the two layers are different) via different linear and non-linear interlayer processes such as, but not limited to, up-sampling, tone mapping, denoising and/or restoration, from temporal reference pictures within the current enhancement layer, and/or from a combination of more than one prediction source. For example, enhancement layer picture 206 may be predicted via an upsampled reference picture 204 of a base layer picture 202. A reconstruction (e.g., a full reconstruction) of the lower layer pictures may be performed. The same mechanism may be employed for scalability extension of HEVC coding.

A reference picture set (RPS) may be a set of reference pictures associated with a picture. A RPS may include reference pictures that may be prior to the associated picture in the decoding order. A RPS may be used for inter prediction of the associated picture and/or a picture following the associated picture in the decoding order. RPS may support temporal motion-compensated prediction within a single layer. A list of RPS may be specified in a sequence parameter set (SPS). At the slice level, methods may be used to describe which reference pictures in the decoded picture buffer (DPB) may be used to predict the current picture and future pictures. For example, the slice header may signal an index to the RPS list in SPS. For example, the slice header may signal the RPS (e.g., signal the RPS explicitly).

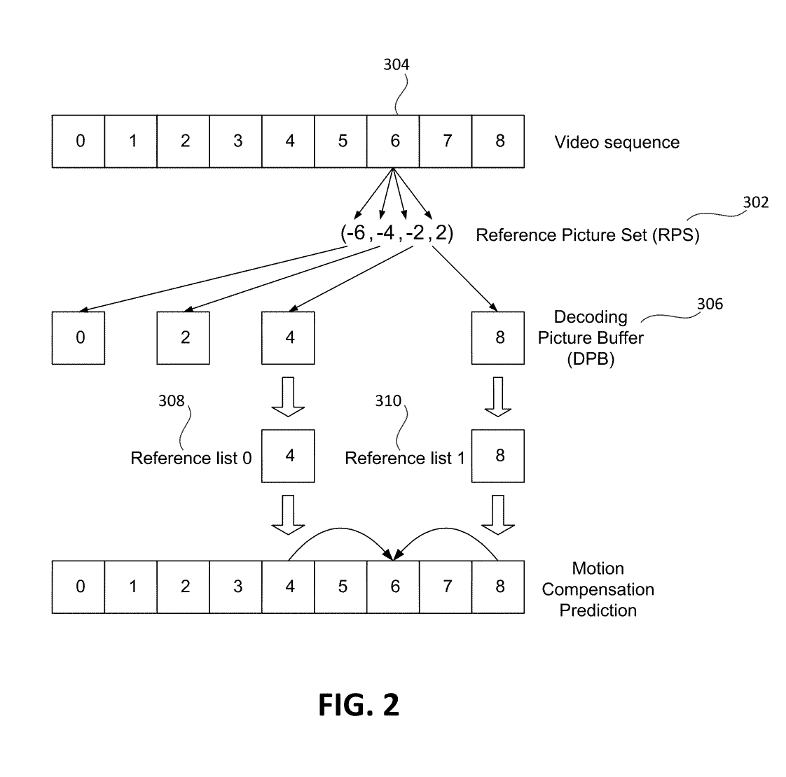

In a RPS, a reference picture (e.g., each reference picture) may be identified through a delta picture order count (POC), which may be the distance between the current picture and the reference picture, for example. FIG. 2 is a diagram illustrating an example of a RPS 302 whereby the POC of the current picture 304 may be 6 and the RPS 302 of current picture 304 may be (−6, −4, −2, 2). As shown in the example of FIG. 2, the reference pictures available in DPB 306 may be the pictures with POC number 0, 2, 4 and 8.

Given the available reference pictures as indicated by the RPS 302, the reference picture lists may be constructed by selecting one or more reference pictures available in the DPB 306. A reference picture list may be a list of reference pictures that may be used for temporal motion compensated prediction of a P slice and/or a B slice. For example, for the decoding process of a P slice, there may be one reference picture list, list 0, 308. For example, for the decoding process of a B slice, there may be two reference picture lists, list0 and list 1, 308, 310.

Still referring to FIG. 2, reference picture lists 308, 310 may include one or more reference pictures. Reference picture list 0 may include one reference picture (e.g., POC 4) and reference picture list 1 may include one reference picture (e.g., POC 8). The encoder and decoder may then use these two reference pictures for motion compensated prediction of the current picture 304.

Table 1 shows an example of a reference picture set, reference pictures stored in DPB, and a reference picture list for the random access common test condition of HEVC with list0 and list 1 size both set to 1.

TABLE 1
An example of a reference picture list of temporal
scalability with one reference picture per list

| Current | | Reference | | | Other pictures |
|---|---|---|---|---|---|
| picture | | pictures in | | | marked as “used |
| (POC) | RPS | DPB (POC) | RefPicList0 | RefPicList1 | for reference” |
| 0 | — | — | — | — | |
| 8 | (−8) | 0 | 0 | 0 | |
| 4 | (−4, 4) | 0, 8 | 0 | 8 | |
| 2 | (−2, 2, 6) | 0, 4, 8 | 0 | 4 | 8 |
| 1 | (−1, 1, 3, 7) | 0, 2, 4, 8 | 0 | 2 | 4, 8 |
| 3 | (−1, −3, 1, 5) | 2, 0, 4, 8 | 2 | 4 | 8 |
| 6 | (−2, −4, −6, 2) | 4, 2, 0, 8 | 4 | 8 | — |
| 5 | (−1, −5, 1, 3) | 4, 0, 6, 8 | 4 | 6 | 8 |
| 7 | (−1, −3, −7, 1) | 6, 4, 0, 8 | 6 | 8 | — |

The video parameter set (VPS) may include a set of parameters for some or all scalable layers, for example, so the advanced middle box may perform VPS mappings without parsing parameters sets of one or more layers. A VPS may include temporal scalability related syntax elements of HEVC. Its NAL unit type may be coded as 15. In SPS, the “video_parameter_set_id” syntax may be used to identify which VPS the video sequence is associated.

The signaling of layer dependency and/or reference picture sets in VPS may be used for the scalable video coding extensions of HEVC. Signaling layer dependency and/or reference picture sets in VPS may be used to support multiple layer scalable extension of HEVC. The VPS concept may include common parameters of some or all layers for extensibility of HEVC, for example, to the extent that the HEVC standard specifies a single layer reference picture set signaling in a SPS or in the slice header. The layer dependency and/or reference picture sets may be common parameters that may be shared by some or all layers for scalable video coding extension of HEVC. One or more of these parameters may be signaled in the VPS. The layer dependency and/or reference picture set signaling may be specified in the VPS, for example, to support temporal and/or inter-layer motion compensated prediction for scalable video coding of HEVC. Layer dependency signaling may be used to indicate the dependency among multiple layers and/or the priority of a dependent layer for inter-layer prediction. The reference picture set signaling may indicate temporal and/or inter-layer reference pictures as common parameters in VPS shared by multiple layers.

Layer dependency may be signaled in a VPS, for example, to indicate the relationship between an enhancement layer and its dependent layers. Layer dependency may be signaled in a VPS, for example, to prioritize the order of the dependent layers for multiple layer scalable video coding of HEVC. Reference picture sets may be signaled in a VPS, for example, for temporal and/or inter-layer prediction for scalable video coding. A reference picture list initialization and/or construction procedure may be described herein. VPS may refer to the VPS and/or the VPS extension of a bit stream.

Elements and features of layer dependency and/or priority signaling designs for HEVC scalable video coding may be provided herein. Any combination of the disclosed features/elements may be used. Scalable video coding may support multiple layers. A layer may be designed to enable spatial scalability, temporal scalability, SNR scalability, and/or any other type of scalability. A scalable bit stream may include mixed scalability layers, whereby a layer may rely on a number of lower layers to be decoded.

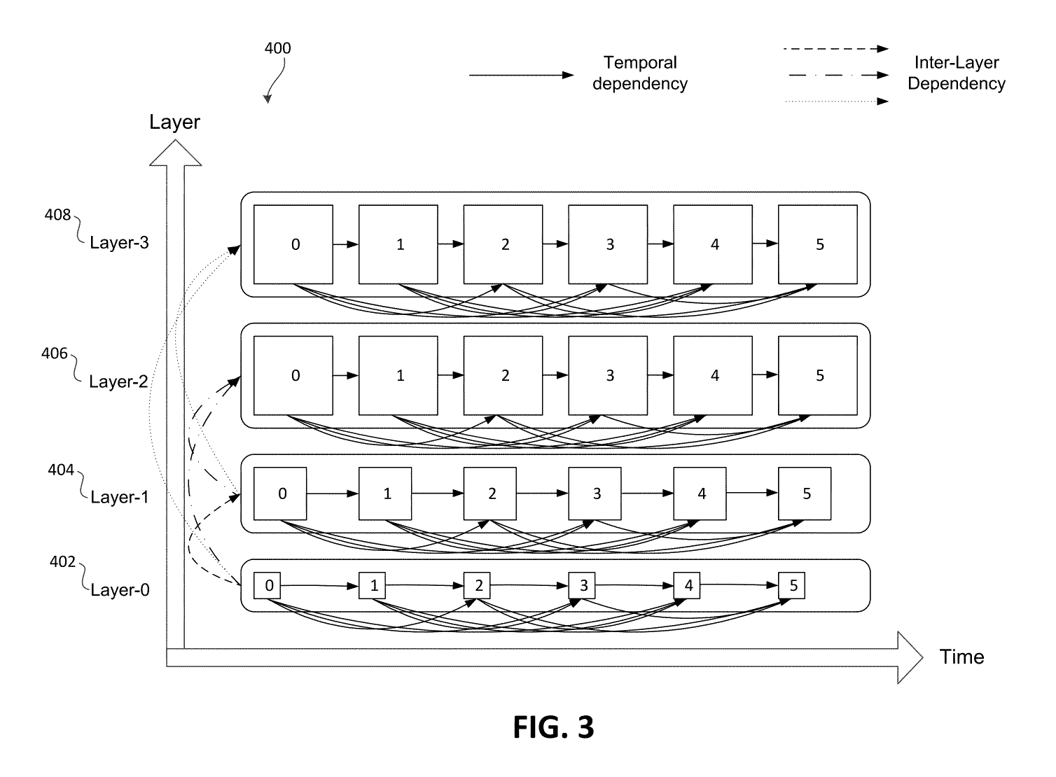

FIG. 3 is an example of a mixed spatial and SNR scalability coding structure 400. Referring to FIG. 3, layer-1 404 may rely on layer-0 402 to be decoded, layer-2 406 may rely on layer-0 402 and layer-1 404 to be decided, and layer-3 408 may rely on layer-0 402 and layer-1 404 to be decoded. Different line dashing may be used to illustrate the inter-layer dependency in FIG. 3. The inter-layer prediction may prioritize the reference pictures from different layers in order to achieve better performance, for example, in addition to coding dependency. For example, layer-2 406 may use one or more up-sampled reconstructed pictures from layer-0 402 and/or layer-1 404 as reference pictures for inter-layer prediction. Layer-2 406 may specify the order of inter-layer reference pictures from dependent layers differently, for example, depending on the up-sampling filter and QP settings of its dependent layers.

VPS syntax (e.g., in a single layer HEVC) may include duplicated temporal scalability parameters from a SPS. VPS syntax (e.g., in a single layer HEVC) may include a VPS flgf, such as a VPS extension flag (e.g., vps_entension_flag), for example, which may be reserved for use by ITU-T|ISO/IEC.

Signaling of layer dependency and/or the priority of dependent layers in a VPS may be provided. For example, one or more of the following parameters may be included into a VPS of a bit stream, for example, to signal layer dependency and/or priority of dependent layers.

A parameter that may be included into a VPS of a bit stream may indicate the maximum number of layers of the bit stream. A maximum number of layers parameter (e.g., MaxNumberOfLayers) may be included in the VPS to signal the maximum number of layers of a bit stream. The maximum number of layers of a bit stream may be the total number of layers of the bit stream. For example, the total number of layers may include a base layer and one or more enhancement layers of the bit stream. For example, if there is one base layer and three enhancement layers within a bit stream, then the maximum number of layers of the bit stream may be equal to four. The maximum number of layers parameter may indicate the number of layers in the bit stream in excess of the base layer (e.g., the total number of layers in the bit stream minus one). For example, since there may always be a base layer in the bit stream, the maximum number of layers parameter may indicate the number of additional layers in the bit stream in excess of one, and therefore provide an indication of the total number of layers in the bit stream.

The VPS may include an indication of the number of dependent layers of a layer of a bitstream, for example, via a number of dependent layers parameter. A parameter that may be included into a VPS of a bit stream may indicate the number of dependent layers for a layer of the bit stream. For example, a total number of dependent layers parameter (e.g., NumberOfDependentLayers[i]) may be included in the VPS to signal a total number of the dependent layers for a layer (e.g., enhancement layer) of a bit stream. For example, if the total number of dependent layers parameter is NumberOfDependentLayers[i], then the variable “i” may indicate the i-th enhancement layer and a number associated with the NumberOfDependentLayers[i] parameter may indicate the number of dependent layers for the i-th enhancement layer. The total number of dependent layers of an enhancement layer may include the enhancement layer, and therefore, the total number of dependent layers parameter may include the enhancement layer. The total number of dependent layers of an enhancement layer may not include the enhancement layer, and therefore, the total number of dependent layers parameter may not include the enhancement layer. The VPS may include a total number of dependent layers parameter for each layer (e.g., for each enhancement layer) of a bit stream. The total number of dependent layers parameter may be included into a VPS of the bit stream, for example, to signal layer dependency of the bit stream for inter layer prediction.

A parameter that may be included into a VPS of a bit stream may indicate an enhancement layer of the bit stream and a dependent layer for the enhancement layer of the bit stream. A dependent layer parameter (e.g., dependent_layer[i][j]) may be included into a VPS. The dependent layer parameter may indicate an enhancement layer and a dependent layer of the enhancement layer. The dependent layer parameter may include an enhancement layer variable and/or a dependent layer variable. The dependent layer parameter may indicate the enhancement layer, for example, via an enhancement layer variable (e.g., “i”). The enhancement layer variable may indicate a layer number of the enhancement layer (e.g., “i” for the i-th enhancement layer). The dependent layer parameter may indicate the dependent layer of the enhancement layer, for example, via a dependent layer variable (e.g., “j”). The dependent layer variable may indicate a layer number or layer identification (ID) (e.g., layer_id) of the dependent layer (e.g., “j” for the j-th enhancement layer, or layer with layer_id “j”). The dependent layer may indicate the order of the dependent layer (e.g., “j” for j-th dependent layer of an enhancement). The dependent layer variable may indicate a difference between the enhancement layer and the dependent layer (e.g., “j” may indicate the difference between the enhancement layer and the dependent layer).

The dependent layer parameter may indicate whether the dependent layer is a dependent layer for the enhancement layer, for example, via a value (e.g., a flag bit) associated with the dependent layer variable. It may be implied that the dependent layer is a dependent layer of the enhancement layer if a dependent layer parameter indicating the enhancement layer and the dependent layer is included in the VPS.

One or more dependent layer parameters may be included in the VPS of a bit stream, for example, for each of the enhancement layers of the bit stream. The VPS may include a dependent layer parameter for one or more of the layers (e.g., each layer) that are lower than the enhancement layer in the bit stream. For example, for an enhancement layer of the bit stream, one or more dependent layer parameters may be included in the VPS that indicate the dependent layer(s) for the enhancement layer. The dependent layer parameter may be utilized to signal layer dependency and/or layer priority of the bit stream, for example, for inter layer prediction.

A parameter that may be included into a VPS of a bit stream may indicate an order of priority of one or more dependent layers of an enhancement layer of the bit stream, for example, for inter layer prediction of the enhancement layer. Dependent layer parameter(s) (e.g., dependent_layer[i][j]) included in the VPS may be used to indicate the priorities of the one or more dependent layers of an enhancement layer. For example, the order of the dependent layer parameter(s) in the VPS may indicate the order of priority of the dependent layers for the enhancement layer. For example, for an enhancement layer, one or more dependent layer parameters may be included into a VPS of the bit stream, and the order in which the one or more dependent layer parameters are included into the VPS may indicate the order of priority of the one or more dependent layers for the enhancement layer. The priority of the one or more dependent layers of an enhancement layer may be the order that reference pictures of the one or more dependent layers are placed in a reference picture set (RPS) of the enhancement layer. The priority of the one or more dependent layers may be independently signaled, for example, using additional bit overhead in the VPS.

The syntax layer_id may not be specified in HEVC. The single-layer HEVC standard may comprise five reserved bits in NAL unit header (e.g., reserved_one_{—}5 bits) which may be used as layer_id for a scalable extension of HEVC.

An example of signaling of layer dependency and/or the priority of dependent layers in a VPS of a bit stream may be described by the following pseudo-code, pseudo-code 1.

| | |
|---|---|
| Pseudo-code 1. | layer dependency and/or priority |

signaling

for (i = 1; i < MaxNumberOfLayers; i ++)
{

NumberOfDependentLayers[i]
for(j = 0; j< NumberOfDependentLayers[i]; j ++)
{

dependent_layer[i][j];

}
}

MaxNumberOfLayers may be a maximum number of layers parameter, for example, as described herein. MaxNumberOfLayers may be a parameter that indicates a total number of coding layers of the bit stream. For example, MaxNumberOfLayers may include the base layer and the one or more enhancement layer(s) of the bit stream. MaxNumberOfLayers may be provided in a VPS of the bit stream.

NumberOfDependentLayer[i] may be a total number of dependent layers parameter, for example, as described herein. NumberOfDependentLayer[i] may be a parameter that indicates a number of dependent layers of the i-th enhancement layer. For example, NumberOfDependentLayer[i] may or may not include the base layer when determining the number of dependent layers of the i-th enhancement layer. NumberOfDependentLayer[i] may be signaled for one of the enhancement layers of the bit stream. NumberOfDependentLayer[i] may be provided in a VPS of the bit stream.

dependent_layer[i][j] may be a dependent layer parameter, for example, as described herein. dependent_layer[i][j] may be a parameter that indicates a dependent layer of an enhancement layer, for example, dependent layer j of the i-th enhancement layer. For example, dependent_layer[i][j] may indicate the layer_id and/or the delta_layer_id of the j-th corresponding dependent layer of the i-th enhancement layer. dependent_layer[i][j] may indicate whether or not the j-th dependent layer is a dependent layer for the i-th enhancement layer. dependent_layer[i][j] may indicate the priority of the dependent layer for the i-th enhancement layer, for example, as described herein. For example, the value j may correspond to the priority of the j-th dependent layer for inter layer prediction of the i-th enhancement layer. dependent_layer[i][j] may be provided in a VPS of the bit stream.

Layer dependency information may be shared by some or all of the scalability layers. An advanced middle box may utilize information relating to layer dependency and/or the priority of dependent layers to more efficiently route data (e.g., a bit stream). An advanced middle box may use dependency information (e.g., at a high level) to efficiently decide whether to pass through or drop the stream NAL packets to fulfill the application requirements. An advanced middle box may be a computer network device that routes, transforms, inspects, filters, and/or otherwise manipulates traffic. For example, an advanced middle box may be a router, a gateway, a server, a firewall, etc.

An advanced middle box may utilize layer dependency and/or the priority of dependent layers signaled in a VPS of a bitstream, for example, to more efficiently route the bit steam to a receiver, such as an end user. An advanced middle box may receive a request from a receiver for an enhancement layer of a bit stream. The advanced middle box may receive the entirety of the bit steam. The advanced middle box may determine the layer dependency of the requested enhancement layer using the VPS of the bit stream, for example, using one or more dependent layer parameters that may be included in the VPS of the bit stream. The advanced middle box may transmit the requested enhancement layer and the dependent layer(s) of the requested enhancement layer to the receiver. The advanced middle box may not transmit (e.g., may remove) layers of the bit stream that are not dependent layers for the requested enhancement layer, for example, since these layers may not be utilized by the receiver to reproduce the requested enhancement layer. Further, the advanced middle box may also not transmit (e.g., may remove) layers of the bit stream that use a removed layer as a dependent layer. Such functionality may allow the advanced middle box to reduce the size of the bit steam transmitted to the receiver without adversely affecting the quality of the requested enhancement layer, for example, to reduce network congestion.

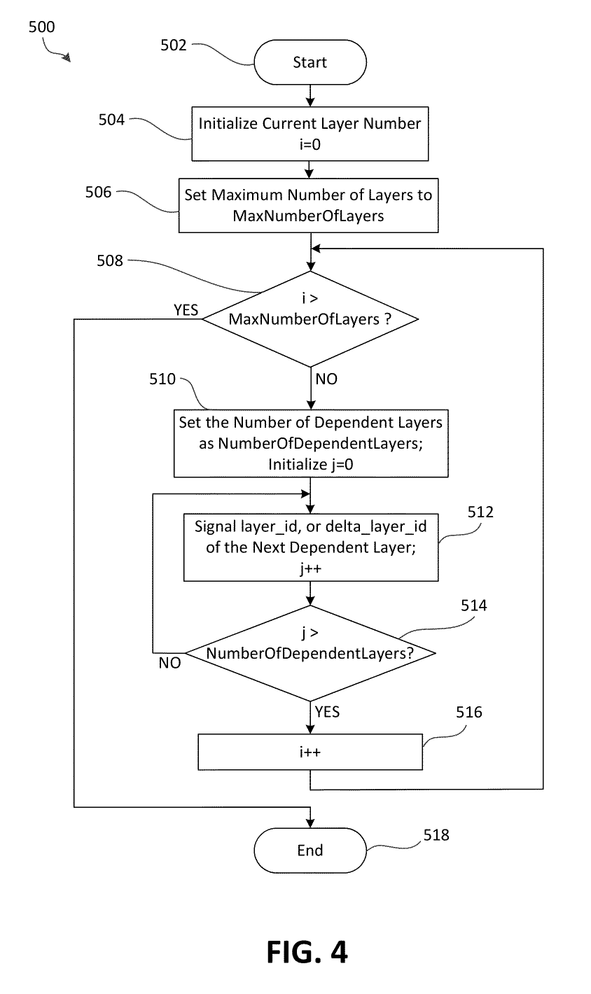

FIG. 4 is a flowchart illustrating an example layer dependency and priority signaling procedure 500. Various approaches may be considered based on whether the current layer belongs to its own dependent layers or not. For example, the current layer may be considered as one of its dependent layers signaled in the VPS. If the current layer is considered as one of its dependent layers signaled in the VPS, then the encoder may prioritize a dependent layer, including current layer, to fulfill the requirements of various applications. The current layer may be used for temporal prediction. The other dependent layers may be used for inter-layer prediction. The current layer may not be considered as one of its own dependent layers. The dependent layers may be for inter-layer prediction. The current layer may be the highest priority layer and temporal prediction may be skipped. If the current layer is not signaled as one of the dependent layers, then temporal prediction may be skipped, and for example, inter-layer prediction (e.g., only inter-layer prediction) may be used.

The signaling procedure 500 may be performed in whole or in part. The signaling procedure 500 begins at 502. At 504, the current layer number (e.g., “i”) may be initialized, for example, “i” may be set to 0). At 506, the maximum number of layers (e.g., MaxNumberOfLayers) may be determined and set. At 508, it may be determined if “i” is greater than the MaxNumberOfLayers. If “i” is greater than the MaxNumberOfLayers, then the signaling procedure may end at 518. If “i” is not greater than the MaxNumberOfLayers, then the number of dependent layers may be determined and set to NumberOfDependentLayers, and the number of dependent layers may be initialized (e.g., “j” may be set to 0) at 510. At 512, layer_id and/or delta layer_id of the next dependent layer may be signaled, and “j” may be increased by 1. At 514, it may be determined if “j” is greater than the NumberOfDependentLayers. If “j” is greater than the NumberOfDependentLayers, then “i” may be increased by 1 at 516, and the procedure may return to 508. If “j” is not greater than the NumberOfDependentLayers, then the procedure may return to 512.

Table 2 shows examples of layer dependency and priority signaling in VPS, for example, for the scalable coding structure of FIG. 3. Table 2(a) provides an example of layer dependency and priority signaling in VPS where the current layer is included as a dependent layer. For example, the signaling of Table 2(a) may indicate that there are a total of four layers. For layer-1, its dependent layer may be layer-0 and it may not use current layer pictures for temporal prediction. For layer-2, its dependent layers may be layer-2, layer-1 and layer-0. Layer-2 may have higher priority than layer-1 and layer-0, and layer-1 may have higher priority than layer-0. For layer-3, its dependent layers may be layer-3, layer-0 and layer-1. Layer-3 may have higher priority than layer-0 and layer-1, and layer-0 may have higher priority than layer-1. Table 2(b) provides an example of layer dependency and priority signaling in VPS where the current layer is not included as a dependent layer.

TABLE 2(a)
Example of layer dependency and priority signaling in VPS

| | | number of | | |
|---|---|---|---|---|
| maximum | current | dependent | | dependent |
| number of | layer ID | layers including | priority | layer ID |
| layers | (layer_id) | the current layer | order | (layer_id) |
| 4 | 1 | 1 | 0 | 0 |
| | 2 | 3 | 0 | 2 |
| | | | 1 | 1 |
| | | | 2 | 0 |
| | 3 | 3 | 0 | 3 |
| | | | 1 | 0 |
| | | | 2 | 1 |

TABLE 2(b)
Example of layer dependency and priority signaling in VPS

| | | number of | | |
|---|---|---|---|---|
| maximum | current | dependent | | dependent |
| number of | layer ID | layers excluding | priority | layer ID |
| layers | (layer_id) | the current layer | order | (layer_id) |
| 4 | 1 | 1 | 0 | 0 |
| | 2 | 2 | 0 | 1 |
| | | | 1 | 0 |
| | 3 | 2 | 0 | 0 |
| | | | 1 | 1 |

Various elements and features relating to reference picture set signaling design for HEVC scalable video coding may be described herein. Any combination of the disclosed features/elements may be utilized. Reference picture set (RPS) prediction and signaling for scalable HEVC video coding may be designed to carry the RPS signaling in a SPS and/or a slice header.

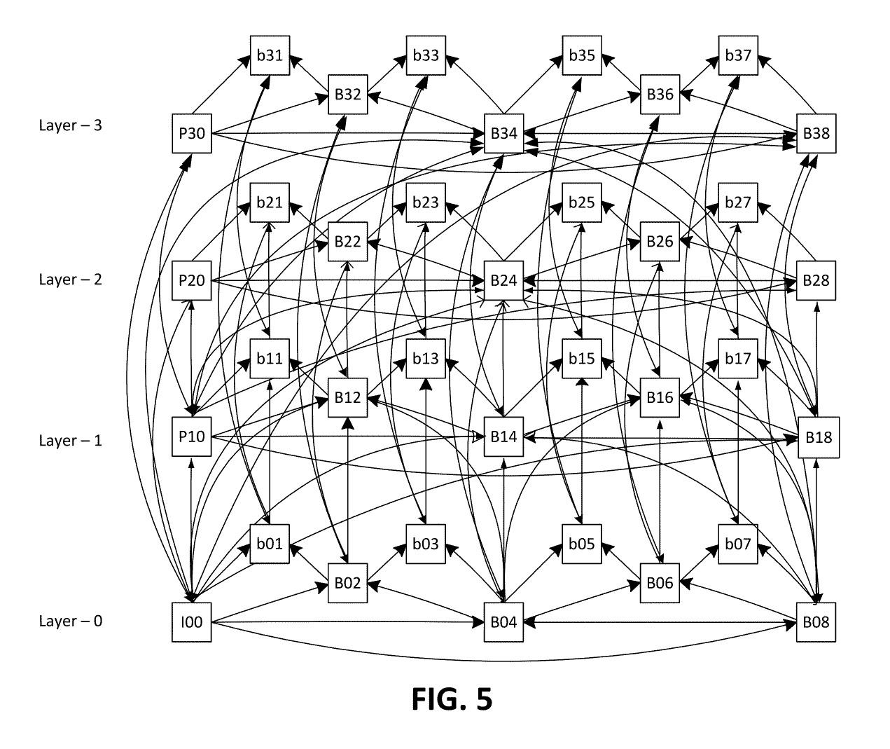

FIG. 5 is a diagram illustrating an example of a scalable video coding with dyadic temporal and inter-layer prediction structure (e.g., all prediction arrows may not be shown in FIG. 5). Temporal prediction may be carried within each layer. A frame (e.g., each frame) of layer-1 may have additional reference pictures, for example, co-located and/or non-co-located, from layer-0 for inter-layer prediction. Layer-2 may have additional reference pictures, for example, co-located and/or non-co-located, from layer-0 and/or layer-1 for inter-layer prediction. The layer dependency and priority signaling (e.g., described herein) may identify the dependent layers for an enhancement layer (e.g., each enhancement layer). Signaling may specify the corresponding reference pictures sets that may be used for each enhancement layer.

A VPS syntax structure may include duplicated temporal scalability parameters from a SPS header and/or a VPS flag (e.g., vps_entension_flag) reserved for use by ITU-T|ISO/IEC. The RPS signaling may be added to the end of a VPS, for example, to specify one or more RPSs used for an enhancement layer. Adding the RPSs related signaling to the end of a VPS may make it easier for middle boxes or smart routers to ignore such signaling as they may not utilize RPS information to make routing decisions.

Reference picture sets may be specified by signaling one or more unique temporal reference picture sets used by one or more enhancement layers. The structure of unique temporal RPS (e.g., UniqueRPS[ ]) may be the same as the structure of the short term temporal reference picture set specified in HEVC. The structure of the unique RPS may be predicted from a base layer's short-term temporal reference picture set. Then, the indices into the unique set of RPSs may be signaled to specify those temporal RPSs it may use. For example, the maximum number of unique reference picture sets may be defined. The maximum number of unique reference picture sets may specify the total number of unique RPSs used by some or all layers. The RPSs used by the base layer may be included or excluded from this set. A set of RPSs in the form of RPS indexes in the unique set may be defined, for example, for each layer. This may be repeated until RPSs for some or all layers have been defined. The example signaling may be described in the following example pseudo-code:

| | |
|---|---|
| Pseudo-code 2. | RPS signaling in VPS |

MaxNumberOfUniqueRPS
for (i = 0; i < MaxNumberOfUniqueRPS; i ++)
{

UniqueRPS[i];

}
for (i = 0; i < MaxNumberOfLayers; I ++)
{

RPS_repeat_flag;
if (!RPS_repeat_flag)
{

NumberOfRPS[i]
for (rps_index_per_layer = 0; rps_index_per_layer
< NumberOfRPS[i];

rps_index_per_layer ++)

{

IndexFromUniqueRPS[i][rps_index_per_layer];

}

} else
{

priority_level;

}

}

MaxNumberOfUniqueRPS may be the total number of unique temporal RPS used by one or more layers. RPS_repeat_flag may be the flag to indicate whether the temporal reference picture sets of the i-th layer are the same as the RPS of one of its one or more dependent layers (e.g., dependent_layer[i] [priority_level] as defined in pseudo-code 1 provided herein). If RPS_repeat_flag equals 1, then the RPS of the current layer may be identical to the RPS of one of its dependent layers. This dependent layer may be the one with the highest priority as specified by “priority_level”; or, as shown in pseudo-code 2, an additional syntax “priority_level” may be used to indicate which dependent layer may be used to repeat the RPS for the current layer. If RPS_repeat_flag equals 0, then the index of RPS mapping to the current layer may be signaled. IndexFromUniqueRPS may include the index of relative UniqueRPS.

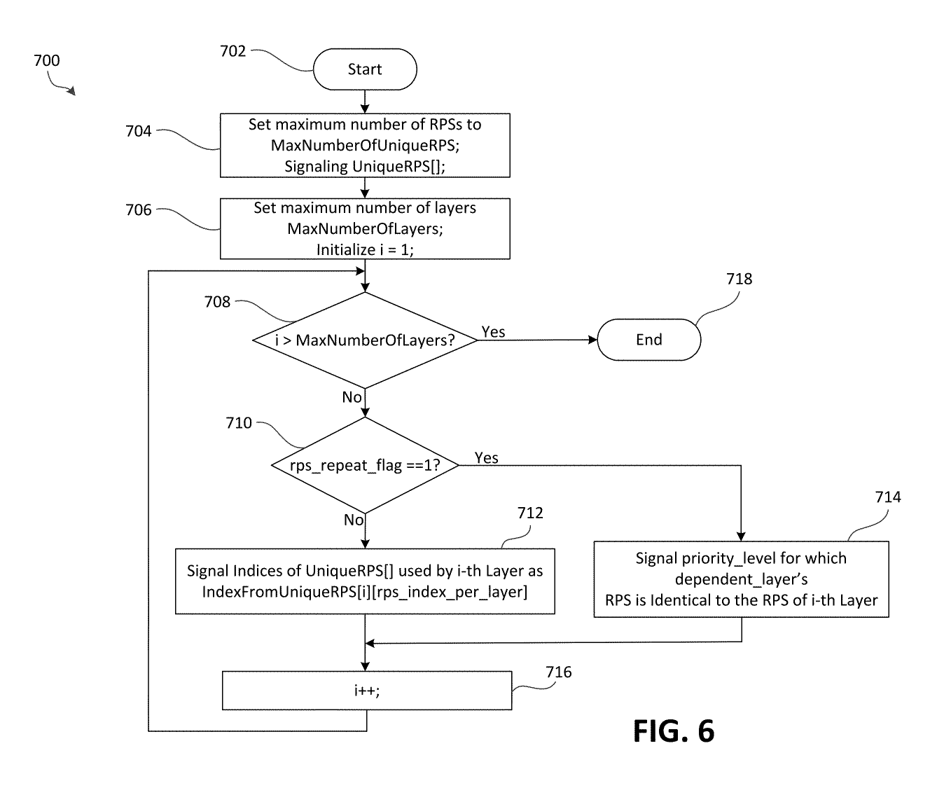

FIG. 6 is a flowchart of an example of RPS signaling in VPS. The procedure 700 may be performed in whole or in part. The procedure 700 may start at 702. At 704, a maximum number of RPSs may be set to MaxNumberOfUniqueRPS, and UniqueRPS[ ] may be signaled. At 706, a maximum number of layers (e.g., MaxNumberOfLayers) may be set, and “i” may be initialized (e.g., “i” may be set to 1). At 708, it may be determined whether “i” is greater than MaxNumberOfLayers. If “i” is greater than MaxNumberOfLayers, then the procedure 700 may end at 718. If “i” is not greater than MaxNumberOfLayers, then it may be determined if a rps_repeat_flag is set to 1 at 710. If the rps_repeat_flag is set to 1, then a priority_level for which a dependent_layer's RPS is identical to the RPS of the i-th layer may be signaled at 714. If the rps_repeat_flag is not set to 1, then indices of UniqueRPS[ ] used by i-th layer as IndexFromUniqueRPS[i][rps_index_per_layer] may be signaled at 712. At 716, “i” may be increased by 1, and the procedure 700 may return to 708.

A three layer scalable coding may be used as an example. Table 3 provides an example of unique temporal RPSs, where each layer may use some or all of the RPSs. Table 4 provides an example of signaling to specify the RPSs used for each layer in VPS. Table 5 provides an example of the RPSs assigned to each layer.

TABLE 3
Example of unique RPS signaling with delta POC

| index | RPS (delta POC) |
|---|---|
| 0 | (−8, −10, −12, −16) |
| 1 | (−4, −6, 4) |
| 2 | (−2, −4, 2, 6) |
| 3 | (−1, 1, 3, 7) |
| 4 | (−1, −3, 1, 5) |
| 5 | (−2, −4, −6, 2) |
| 6 | (−1, −5, 1, 3) |
| 7 | (−1, −3, −7, 1) |

TABLE 4
Example of signaling RPS for each layer in VPS

| | | | LayerRPS |
|---|---|---|---|
| layer | RPS_repeat_flag | rps_index_per_layer | (index) |
| 0 | 0 | 0 | 0 |
| | | 1 | 1 |
| | | 2 | 2 |
| | | 3 | 3 |
| 1 | 0 | 0 | 4 |
| | | 1 | 5 |
| | | 2 | 6 |
| | | 3 | 7 |
| 2 | 1 | | − |

TABLE 5
Example of reference picture sets assigned to each layer

| layer | rps_index_per_layer | RPS index | RPS (delta POC) |
|---|---|---|---|
| 0 | 0 | 0 | (−8, −10, −12, −16) |
| | 1 | 1 | (−4, −6, 4) |
| | 2 | 2 | (−2, −4, 2, 6) |
| | 3 | 3 | (−1, 1, 3, 7) |
| 1 | 0 | 4 | (−1, −3, 1, 5) |
| | 1 | 5 | (−2, −4, −6, 2) |
| | 2 | 6 | (−1, −5, 1, 3) |
| | 3 | 7 | (−1, −3, −7, 1) |
| 2 | 0 | 4 | (−1, −3, 1, 5) |
| | 1 | 5 | (−2, −4, −6, 2) |
| | 2 | 6 | (−1, −5, 1, 3) |
| | 3 | 7 | (−1, −3, −7, 1) |

The RPS_repeat_flag in pseudo code 2 may be omitted, for example, in which case the indexFromUniqueRPS for each layer may be signaled in the VPS.

The reference picture set for a layer may be signaled without mapping the RPS index for a layer in the VPS. For example, the reference picture set for each layer may be signaled without mapping the RPS index for each layer in the VPS. For example, the maximum number of reference picture sets may be defined for a layer (e.g., each layer). One RPS may be signaled for the current layer using, for example, the difference of picture order count values between the frame being coded and each reference frame. This may be repeated until some or all RPSs of the current layer are signaled. The procedure may continue to the next layer and repeated until some or all layers' RPSs are signaled. For example, the example signaling may be described in the following example pseudo-code:

| | |
|---|---|
| Pseudo-code 3. | RPS signaling in VPS |

for (i = 0; i < MaxNumberOfLayers; i++)
{

NumberOfRPSs[i];
for (rps_index_per_layer = 0; rps_index_per_layer <
NumberOfRPS[i];

rps_index_per_layer ++)

{

RPS[i][rps_index_per_layer];

}

}

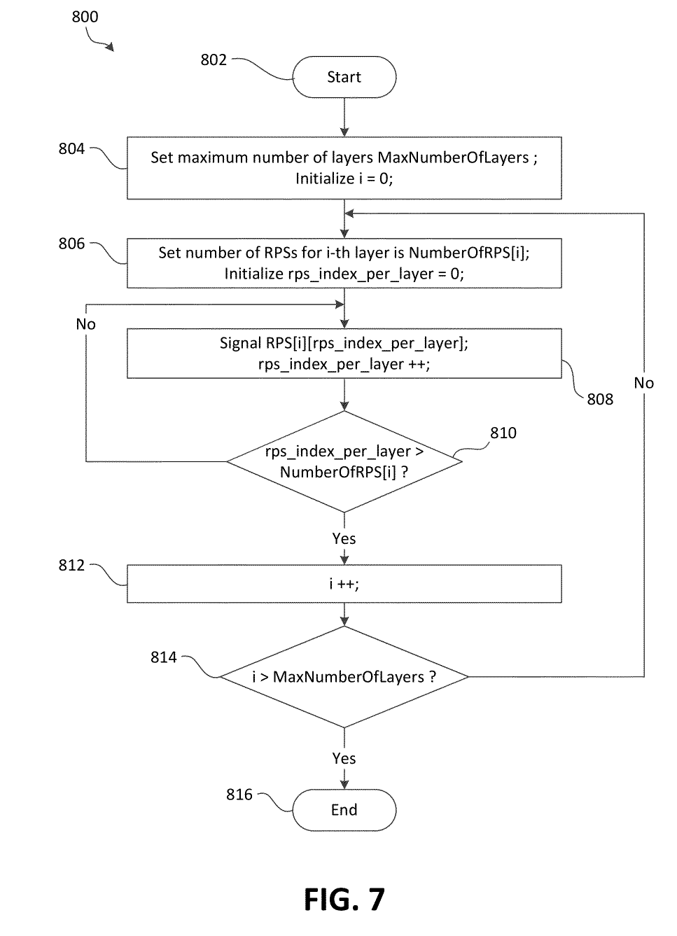

FIG. 7 is a flow chart of another example reference picture set arrangement in VPS. The VPS signaling bits may be reduced, for example, if each layer uses different RPSs. If two or more layers share the same or partially the same RPSs, more bits may be used to signal duplicated RPSs in VPS. For example, the RPSs listed in Table 5 may be signaled for each layer.

The procedure 800 may be performed in whole or in part. The procedure 800 may start at 802. At 804, a maximum number of layers MaxNumberOfLayers may be determined and set, and “i” may be set to 0. At 806, a number of RPSs for the i-th layer may be set to NumberOfRPS[i], and rps_indexper_layer may be set to 0. At 808, RPS[i][rps_indexper_layer] may be signaled, and rps_indexper_layer may be increased by 1. At 810 it may be determined whether rps_indexper_layer is greater than NumberOfRPS[i]. If rps_indexper_layer is not greater than NumberOfRPS[i], then the procedure 800 may return to 808. If rps_indexper_layer is greater than NumberOfRPS[i], then “i” may be increased by 1 at 812. At 814 it may be determined whether “i” is greater than MaxNumberOfLayers. If “i” is not greater than MaxNumberOfLayers, then the procedure 800 may return to 806. If “i” is greater than MaxNumberOfLayers, then the procedure 800 may end at 816.

One or more flags may be introduced to indicate if the RPSs of a given layer can be duplicated from more than one of its dependent layers, and if so, which dependent layers.

A reference picture list may include part or all of the reference pictures indicated by reference picture set for the motion compensated prediction of the current slice and/or picture. The construction of one or more reference picture lists for a single layer video codec, for example, in HEVC, may occur at the slice level. For scalable HEVC coding, extra inter-layer reference pictures from one or more dependent layers may be marked and/or may be included into the one or more reference picture lists for the current enhancement layer slice and/or picture.

The reference picture list may be constructed in combination with the layer dependency signaling and/or reference picture sets design schemes described above.

The reference picture list may add the reference pictures from the dependent layer with highest priority, followed by the reference pictures from the dependent layer with the second highest priority, and so on until the reference pictures from the dependent layers have been added. This may be performed for a given layer, and based on the priority of its one or more dependent layers previously signaled in VPS. For example, because the reference pictures from a dependent layer used in inter-layer prediction of the current enhancement may be those pictures currently stored in the dependent layer's DPB, and because, in a dependent layer, the pictures stored in the DPB of that layer may be determined by the dependent layer's temporal RPS, the inter-layer reference pictures may be inferred from the temporal RPS referenced by the co-located reference picture of the dependent layer.

For example, a scalable coding structure as shown in FIG. 5 may have four layers. The dependent layers of layer-3 may include layer-3, layer-1, and layer-0. The dependent layers of layer-3 may be signaled in VPS, for example, as described herein. The RPS signaling may identify the temporal RPSs that may be used for layer-3, layer-1, and layer-0. Since layer-3 may be the dependent layer with highest priority, its temporal reference pictures may be added into the reference picture lists first, followed by the inter-layer reference pictures from layer-1, then followed by the inter layer reference pictures from layer-0. The inter-layer reference picture from layer-1 may be derived from the RPS reference in the slice header of the co-located reference picture from layer-1. For example, if B34 is the current picture at layer-3, then its temporal reference pictures may include P30 and B38. B14 and B04 may be the co-located reference picture in its dependent layer layer-1 and layer-0 for current picture B34. The temporal RPS referenced by B14 may indicate that P10 and B18 are the reference pictures available in layer-1's DPB, and the temporal RPS referenced by B04 may indicate that I00 and B08 are the reference pictures available in layer-0's DPB. Therefore, the inter-layer reference pictures for layer-3 picture B34 may include B14, P10 and B18 from layer-1, followed by B04, I00 and B08 from layer-0.

The index of the temporal RPS referenced in the slice header of an coded picture and/or slice of the i-th enhancement layer may be an index into the set of UniqueRPS in the VPS, for example, as provided by Pseudo-code 2. The index of the temporal RPS referenced in the slice header of an coded picture and/or slice of the i-th enhancement layer may be an index into the set of UniqueRPS in the VPS and/or an index into the remapped RPS[i][rps_index_per_layer] (e.g., as provided by Pseudo-code 2 and/or Pseudo-code 3), for example, to save signaling overhead in the slice header. Table 4 and Table 5 provide examples of the index value signaled for each layer.

HEVC may specify flags, used_by_curr_pic_s0_flag and used_by_curr_pic_s1_flag, to indicate if the relative reference picture may be used for reference by the current picture. For example, these one-bit flags may be used for temporal prediction within the single layer in HEVC. For scalable coding, these two flags may be valid for signaling temporal reference pictures within a given layer. For example, for inter-layer prediction, these two flags, used_by_curr_pic_s0_flag and used_by_curr_pic_s1_flag, may be used to indicate if the corresponding reference picture from the dependent layer may be used for inter-layer prediction. These flags may be ignored for inter-layer prediction, and one or more reference pictures available in the DPB of a dependent layer may be used for inter-layer prediction of current picture.

The co-located picture from a dependent layer (e.g., each dependent layer) may be used as reference picture(s) for inter-layer prediction of the coding picture in the current layer. The temporal RPS for a picture may indicate its temporal reference pictures. The temporal RPS for a picture may not indicate the current picture itself. The encoder and/or decoder may include co-located reference picture from the dependent layer, for example, in addition to adding a non-co-located inter-layer reference pictures from the same dependent layer into the reference picture lists.

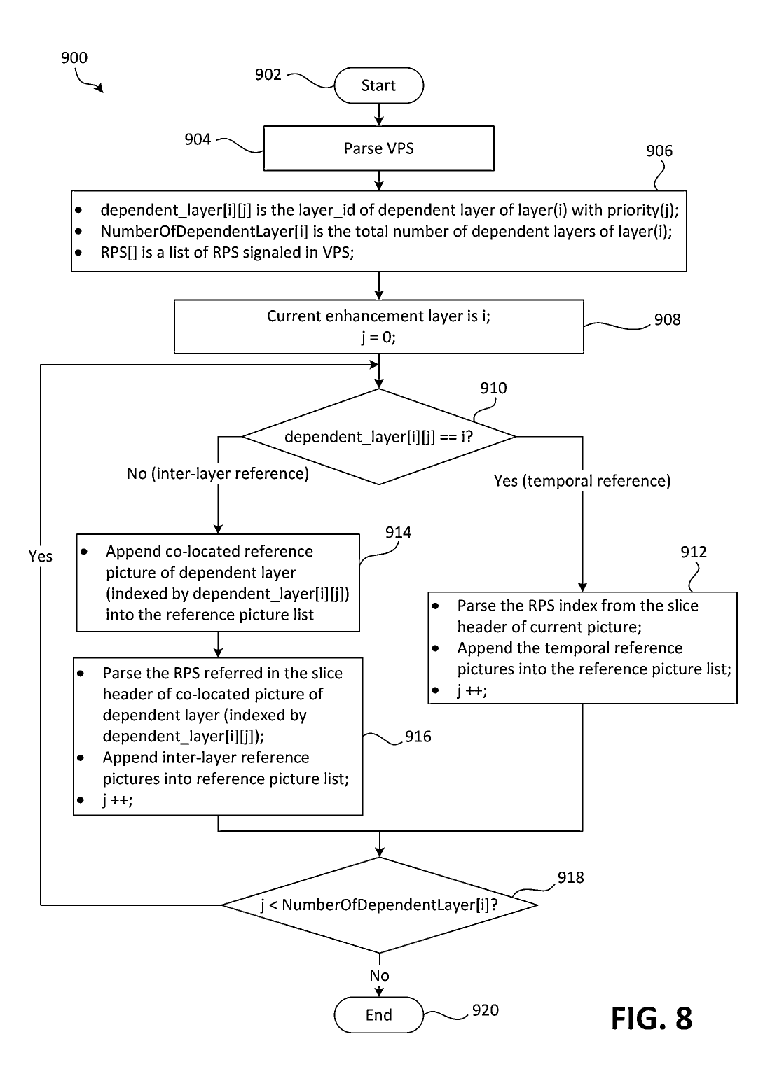

FIG. 8 is a flowchart of an example decoding process of reference picture list initialization and construction. The procedure 900 may be performed in whole or in part. The procedure 900 may start at 902. At 904, the VPS may be parsed. At 906, dependent_layer[i][j] may be set as the layer_id of the dependent layer of layer(i) with priority(j), the NumberOfDependentLayer[i] may be determined and set as the total number of dependent layers of layer(i), and/or RPS[ ] may be set as a list of RPS signaled in the VPS. At 908, the current enhancement layer may be “i”, and “j” may be set to 0. At 910 it may be determined if dependent_layer[i][j] is equal to “i”. If dependent_layer[i][j] is equal to “i”, then the reference picture from the dependent layer may be used for temporal prediction. If dependent_layer[i][j] is equal to “i”, then at 912 the RPS index from the slice header of the current picture may be parsed, the temporal reference pictures may be appended into the reference picture list, and/or “j” may be increased by 1. If dependent_layer[i][j] is not equal to “i”, then the reference picture from the dependent layer may be used for inter-layer prediction. If dependent_layer[i][j] is not equal to “i”, then the co-located reference picture of the dependent layer (e.g., indexed by dependent_layer[i][j]) may be appended into the reference picture list at 914. At 916, the RPS referred in the slice header of the co-located picture of the dependent layer (e.g., indexed by dependent_layer[i][j]) may be parsed, the inter-layer reference pictures may be appended into the reference picture list, and/or “j” may be increased by 1. At 918, it may be determined if “j” is less than the NumberOfDependentLayer[i]. If “j” is less than the NumberOfDependentLayer[i], then the procedure 900 may return to 910. If “j” is not less than the NumberOfDependentLayer[i], then the procedure 900 may end at 920.

Table 6 is an example of reference picture list construction for two pictures, B24 at layer-2 and B34 at layer-3 (e.g., as shown in FIG. 5). For this example, the dependent layers of layer-2 may be layer-2, layer-1 and layer-0, and may be in that order of priority. The dependent layers of layer-3 may be layer-3, layer 0 and layer-1, and may be in that order of priority. The same temporal RPS (−4, 4) may be signaled for frame B24 and B34. The list RefPicListTemp0 and RefPicListTemp1 (e.g., which may be specified in HEVC) may be formed by a reference picture from the highest priority first, followed by reference pictures from following dependent layers. For example, the co-located reference picture I00, P10 and P20 (e.g., B₁4 and B₀4) may be placed prior to any non-co-located reference pictures of the same dependent layer. The temporary lists RefPicListTemp0 and RefPicListTemp1 may be used to construct the final list0 and list1, for example, by taking the first size of list0 and size_of list1 entries to form the default lists and/or by applying reference picture list modification to obtain list0 and/or list1 that may be different from the default lists.

TABLE 6
Example of reference picture list construction example

| | | depen- | temporal | | |
|---|---|---|---|---|---|
| | | dent | RPS per | | |
| layer | frame | layer | layer | RefPicListTemp0 | RefPicListTemp1 |
| 2 | B₂4 | 2 | (−4, 4) | P₂0-B₂8- | B₂8-P₂0- |
| | | 1 | (−4, 4) | B₁4-P₁0-B₁8- | B₁4-B₁8-P₁0- |
| | | 0 | (−4, 4) | B₀4-I₀0-B₀8 | B₀4-B₀8-I₀0 |
| 3 | B₃4 | 3 | (−4, 4) | P₃0-B₃8- | B₃8-P₃0- |
| | | 0 | (−4, 4) | B₀4-I₀0-B₀8- | B₀4-B₀8-I₀0- |
| | | 1 | (−4, 4) | B₁4-P₁0-B₁8 | B₁4-B₁8-P₁0 |

RPS signaling and reference picture list construction processes described herein may be used in the context of VPS. RPS signaling and reference picture list construction processes described herein may be implemented within the context of other high level parameter sets, such as, but not limited to Sequence Parameter Set extensions or Picture Parameter Set, for example.

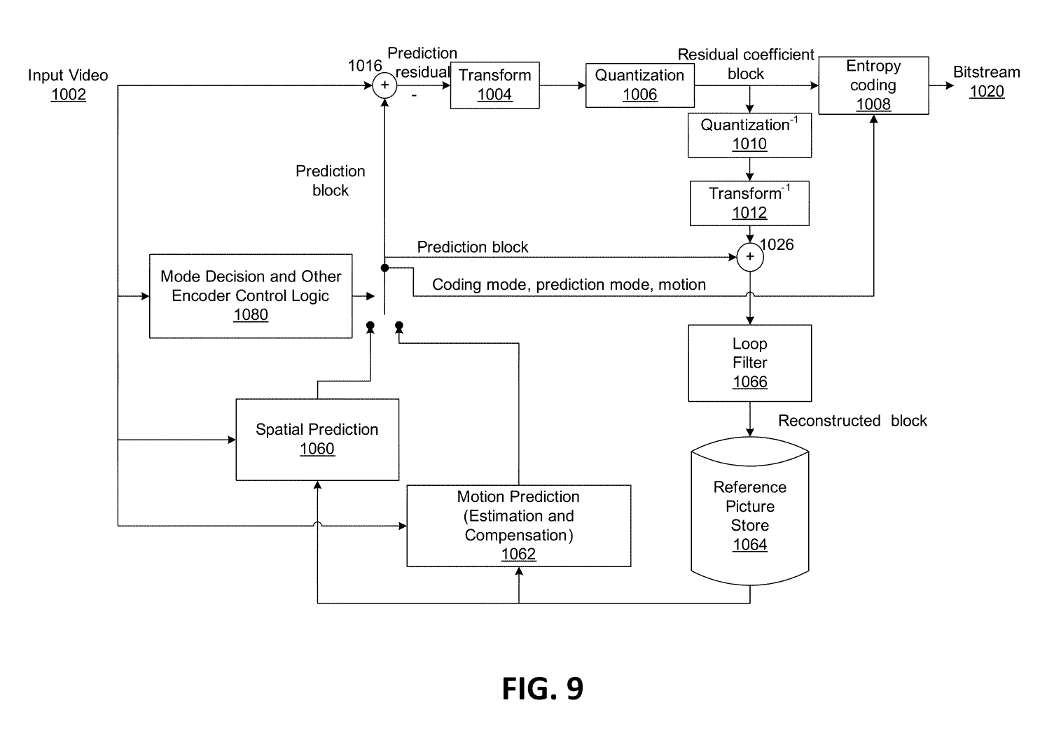

FIG. 9 is a block diagram illustrating an example of a block-based video encoder, for example, a block-based hybrid video encoding system). A input video signal 1002 may be processed block by block. The video block unit may include 16×16 pixels. Such a block unit may be referred to as a macroblock (MB). In High Efficiency Video Coding (HEVC), extended block sizes (e.g., which may be referred to as a “coding unit” or CU) may be used to efficiently compress high resolution (e.g., 1080p and beyond) video signals. In HEVC, a CU may be up to 64×64 pixels. A CU may be partitioned into prediction units (PUs), for which separate prediction methods may be applied. For an input video block (e.g., a MB or a CU), spatial prediction (1060) and/or temporal prediction (1062) may be performed.

Spatial prediction (e.g., “intra prediction”) may use pixels from already coded neighboring blocks in the same video picture/slice to predict the current video block. Spatial prediction may reduce spatial redundancy inherent in the video signal. Temporal prediction (e.g., “inter prediction” or “motion compensated prediction”) may use pixels from already coded video pictures (e.g., which may be referred to as “reference pictures”) to predict the current video block. Temporal prediction may reduce temporal redundancy inherent in the video signal. A temporal prediction signal for a given video block may be signaled by one or more motion vectors, which may indicate the amount and/or the direction of motion between the current block and its prediction block in the reference picture. If multiple reference pictures are supported (e.g., as may be the case for H.264/AVC and/or HEVC), then for a video block, its reference picture index may be sent additionally. The reference index may be used to identify from which reference picture in the reference picture store (1064) (e.g., which may be referred to as a “decoded picture buffer” or DPB) the temporal prediction signal comes.

After spatial and/or temporal prediction, the mode decision block (1080) in the encoder may select a prediction mode. The prediction block may be subtracted from the current video block (1016). The prediction residual may be transformed (1004) and quantized (1006). The quantized residual coefficients may be inverse quantized (1010) and inverse transformed (1012) to form the reconstructed residual, which may be added back to the prediction block (1026) to form the reconstructed video block.

In-loop filtering such as, but not limited to a deblocking filter, a Sample Adaptive Offset, and/or Adaptive Loop Filters may be applied (1066) on the reconstructed video block before it is put in the reference picture store (1064) and/or used to code future video blocks. To form the output video bitstream 1020, a coding mode (inter or intra), prediction mode information, motion information, and/or quantized residual coefficients may be sent to the entropy coding unit (1008) to be compressed and packed to form the bitstream.

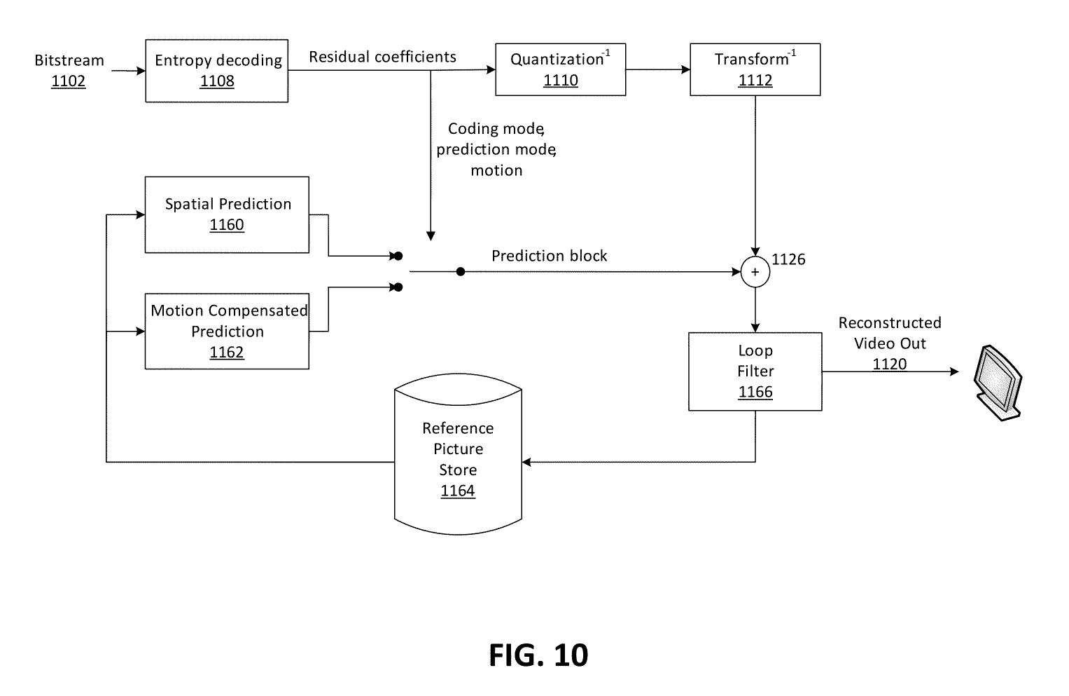

FIG. 10 is a block diagram illustrating an example of a block-based video decoder. A video bitstream 1102 may be unpacked and entropy decoded at entropy decoding unit 1108. The coding mode and prediction information may be sent to the spatial prediction unit 1160 (e.g., if intra coded) and/or the temporal prediction unit 1162 (e.g., if inter coded) to form the prediction block. If inter coded, the prediction information may comprise prediction block sizes, one or more motion vectors (e.g., which may indicate direction and amount of motion) and/or one or more reference indices (e.g., which may indicate from which reference picture the prediction signal is to be obtained).

Motion compensated prediction may be applied by the temporal prediction unit 1162 to form the temporal prediction block. The residual transform coefficients may be sent to inverse quantization unit 1110 and inverse transform unit 1112 to reconstruct the residual block. The prediction block and the residual block may be added together at 1126. The reconstructed block may go through in-loop filtering before it is stored in reference picture store 1164. The reconstructed video in reference picture store 1164 may be used to drive a display device, and/or used to predict future video blocks.

A single layer video encoder may take a single video sequence input and generate a single compressed bit stream transmitted to the single layer decoder. A video codec may be designed for digital video services (e.g., such as but not limited to sending TV signals over satellite, cable and terrestrial transmission channels). With video centric applications deployed in heterogeneous environments, multi-layer video coding technologies may be developed as an extension of the video coding standards to enable various applications. For example, scalable video coding technologies may be designed to handle more than one video layer where each layer may be decoded to reconstruct a video signal of a particular spatial resolution, temporal resolution, fidelity, and/or view. Although a single layer encoder and decoder are described with reference to FIG. 9 and FIG. 10, the concepts described herein may utilize a multi-layer encoder and decoder, for example, for multi-layer or scalable coding technologies.

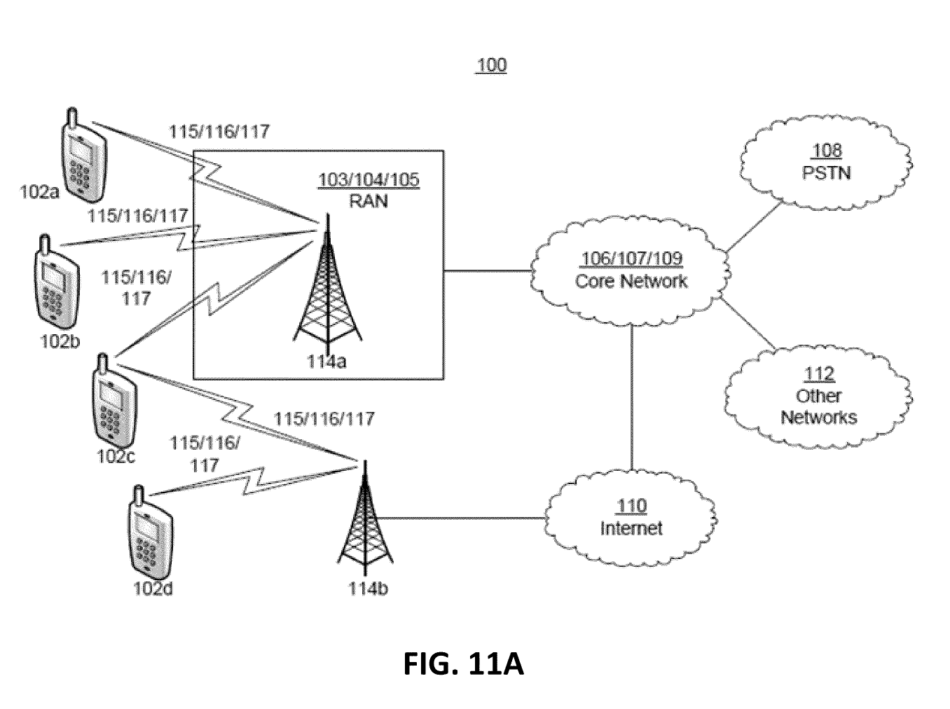

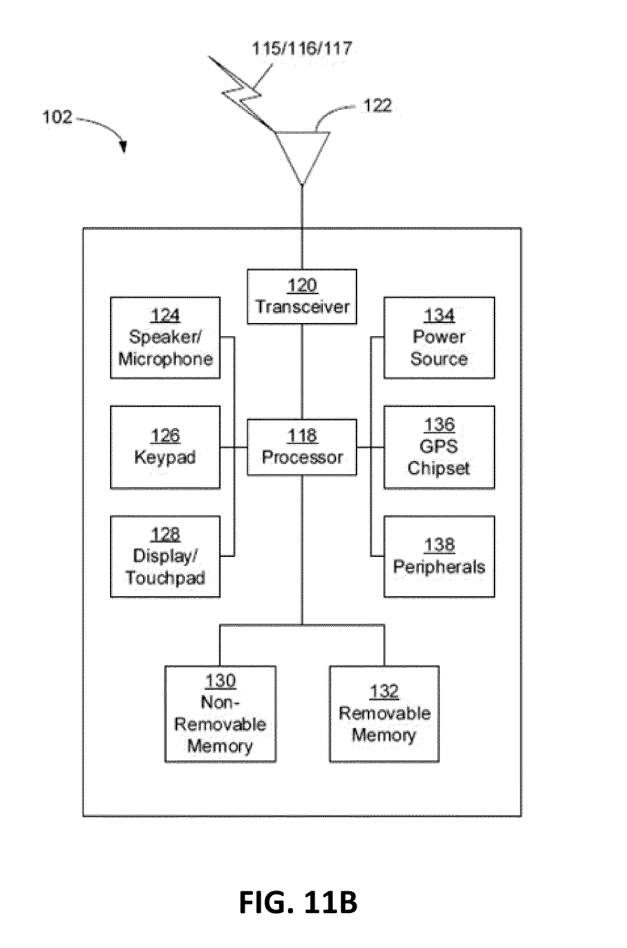

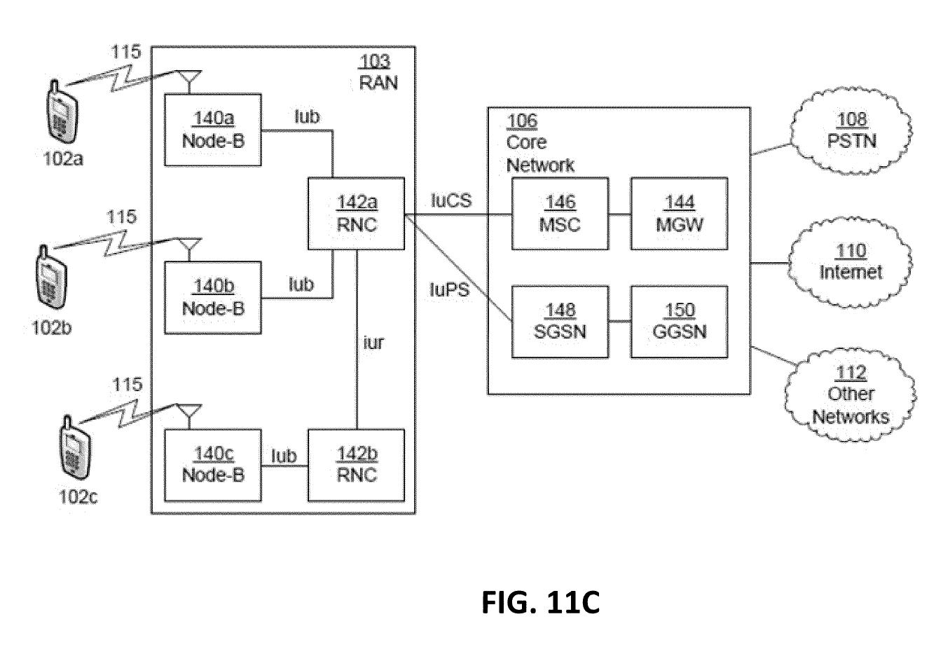

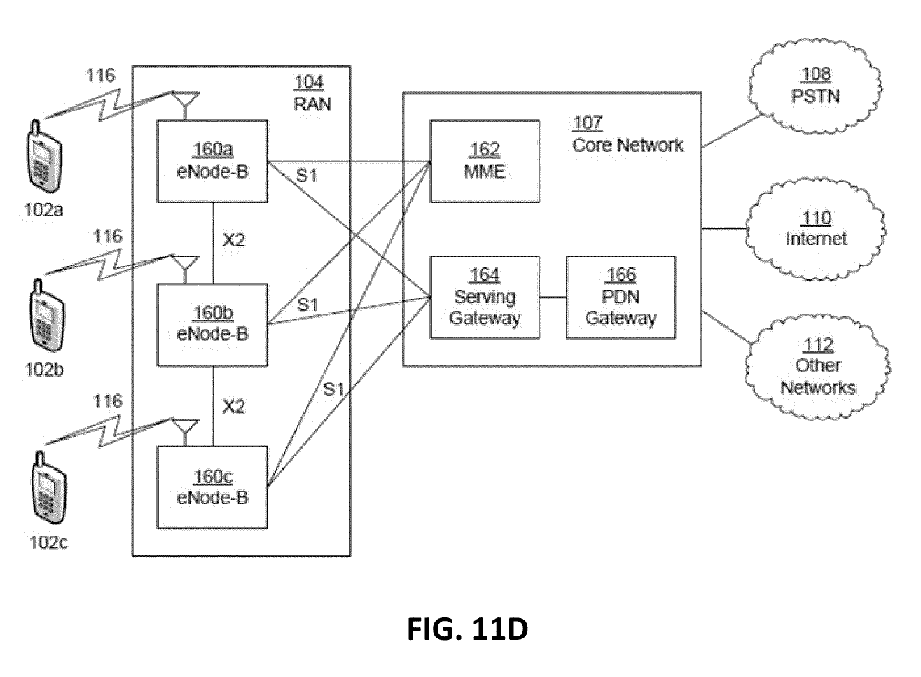

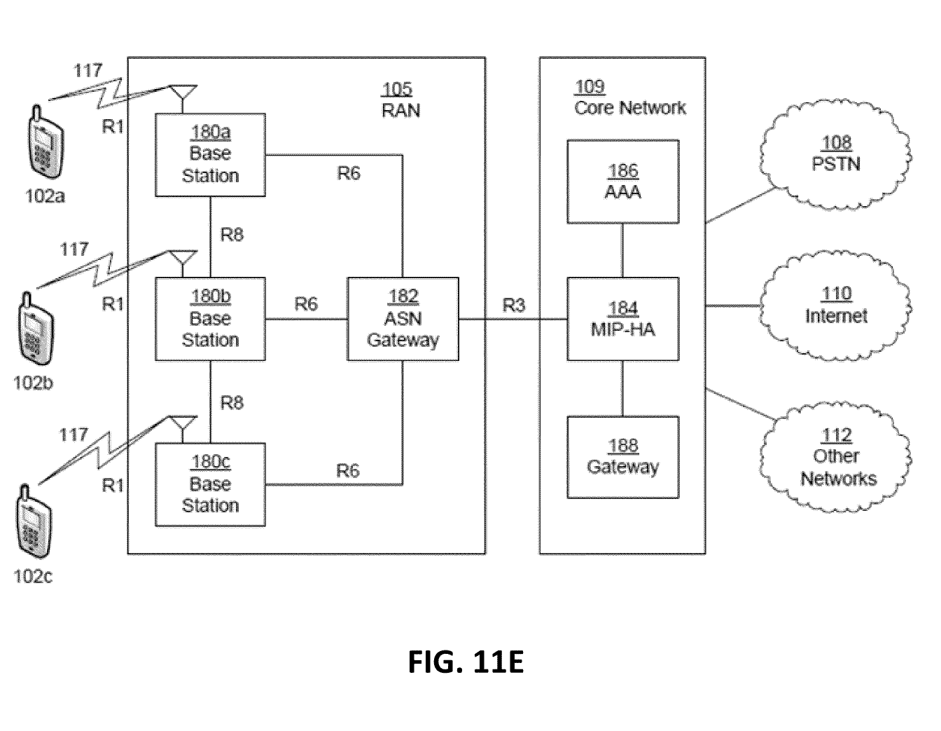

FIG. 11A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 11A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 11A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 11A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 11A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 11A may be configured to communicate with the base station 114a, which may employ a cellular-based radio technology, and with the base station 114b, which may employ an IEEE 802 radio technology.

FIG. 11B is a system diagram of an example WTRU 102. As shown in FIG. 11B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. It is noted that the components, functions, and features described with respect to the WTRU 102 may also be similarly implemented in a base station.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 11B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 11B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 11C is a system diagram of the RAN 104 and the core network 106 according to an embodiment. As noted above, the RAN 104 may employ a UTRA radio technology to communicate with the WTRUs 102a, 102b, 102c over the air interface 116. The RAN 104 may also be in communication with the core network 106. As shown in FIG. 11C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 11C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 11C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 11D is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 11D, the eNode-Bs 140a, 140b, 140c may communicate with one another over an X2 interface.

The core network 106 shown in FIG. 11C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 11E is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 11E, the RAN 104 may include base stations 140a, 140b, 140c, and an ASN gateway 142, though it will be appreciated that the RAN 104 may include any number of base stations and ASN gateways while remaining consistent with an embodiment. The base stations 140a, 140b, 140c may each be associated with a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 11E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 11E, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

The techniques discussed may be performed partially or wholly by a WTRU 102a, 102b, 102c, 102d, a RAN 104, a core network 106, the Internet 110, and/or other networks 112. For example, video streaming being performed by a WTRU 102a, 102b, 102c, 102d may engage various multilayer processing as discussed below.

The processes described above may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method comprising:
receiving a bit stream that comprises a video parameter set (VPS), wherein the VPS comprises a dependent layer parameter that indicates a dependent layer for an enhancement layer of the bit stream; and
performing inter-layer prediction of the enhancement layer using the dependent layer.

2. The method of claim 1, wherein the dependent layer parameter indicates a layer identification (ID) of the dependent layer.

3. The method of claim 2, wherein the dependent layer parameter indicates the layer ID of the dependent layer as a function of a difference between the dependent layer and the enhancement layer.

4. The method of claim 1, wherein the VPS indicates a total number of dependent layers for the enhancement layer.

5. The method of claim 4, wherein the total number of dependent layers for the enhancement layer does not include the enhancement layer.

6. The method of claim 1, wherein the enhancement layer has one or more dependent layers, and wherein an order of one or more dependent layer parameters in the VPS indicates a priority of the one or more dependent layers for inter-layer prediction of the enhancement layer.

7. The method of claim 1, wherein the VPS comprises a maximum number of layers parameter that indicates a total number of layers of the bit stream.

8. The method of claim 1, wherein the bit stream is encoded according to a high efficiency video coding (HEVC) coding standard.

9. A device comprising:
a processor configured to:
receive a bit stream that comprises a video parameter set (VPS), wherein the VPS comprises a dependent layer parameter that indicates a dependent layer for an enhancement layer of the bit stream; and
perform inter-layer prediction of the enhancement layer using the dependent layer.

10. The device of claim 9, wherein the dependent layer parameter indicates a layer identification (ID) of the dependent layer.

11. The device of claim 10, wherein the dependent layer parameter indicates the layer ID of the dependent layer as a function of a difference between the dependent layer and the enhancement layer.

12. The device of claim 9, wherein the VPS indicates a total number of dependent layers for the enhancement layer.

13. The device of claim 12, wherein the total number of dependent layers for the enhancement layer does not include the enhancement layer.

14. The device of claim 9, wherein the enhancement layer has one or more dependent layers, and wherein an order of one or more dependent layer parameters in the VPS indicates a priority of the one or more dependent layers for inter-layer prediction of the enhancement layer.

15. The device of claim 9, wherein the VPS comprises a maximum number of layers parameter that indicates a total number of layers of the bit stream.

16. The device of claim 9, wherein the device is a decoder.

17. The device of claim 9, wherein the device is a wireless transmit/receive unit (WTRU).

18. A method of signaling inter-layer dependency in a video parameter set (VPS), the method comprising:
defining two or more layers for a bit stream;
defining a dependent layer for an enhancement layer of the bit stream; and
signaling, via the VPS, a dependent layer parameter that indicates the dependent layer for the enhancement layer of the bit stream.

19. The method of claim 18, wherein the dependent layer parameter indicates a layer identification (ID) of the dependent layer.

20. The method of claim 18, wherein the VPS indicates a total number of dependent layers for the enhancement layer.

21. The method of claim 18, comprising:
defining one or more dependent layers for the enhancement layer; and
signaling, via the VPS, one or more dependent layer parameters that indicate the one or more dependent layers for the enhancement layer, wherein an order of the one or more dependent layer parameters in the VPS indicates a priority of the one or more dependent layers for inter-layer prediction of the enhancement layer.

22. The method of claim 18, wherein the VPS comprises a maximum number of layers parameter that indicates a total number of layers of the bit stream.

23. A device configured to signal inter-layer dependency in a video parameter set (VPS), the device comprising:
a processor configured to:
define two or more layers for a bit stream;
define a dependent layer for an enhancement layer of the bit stream; and
signal, via the VPS, a dependent layer parameter that indicates the dependent layer for the enhancement layer of the bit stream.

24. The device of claim 23, wherein the dependent layer parameter indicates a layer identification (ID) of the dependent layer.

25. The device of claim 23, wherein the VPS indicates a total number of dependent layers for the enhancement layer.

26. The device of claim 23, wherein the processor is configured to:
define one or more dependent layers for the enhancement layer; and
signal, via the VPS, one or more dependent layer parameters that indicate the one or more dependent layers for the enhancement layer, wherein an order of the one or more dependent layer parameters in the VPS indicates a priority of the one or more dependent layers for inter-layer prediction of the enhancement layer.

27. The device of claim 23, wherein the VPS comprises a maximum number of layers parameter that indicates a total number of layers of the bit stream.

28. The device of claim 23, wherein the device is an encoder.

29. The device of claim 23, wherein the device is a wireless transmit/receive unit (WTRU).
